(19) United States
(12) Patent Application Publication
(10) Pub. No.: US 2023/0252443 A1
(43) Pub. Date: Aug. 10, 2023

(54) CHECKOUT PRODUCT RECOGNITION TECHNIQUES

(71) Applicant: NCR Corporation, Atlanta, GA (US)

(72) Inventors: Christian Lee McDaniel, Atlanta, GA (US); Stefan Bjelcevic, Roswell, GA (US); Brent Vance Zucker, Roswell, GA (US)

(21) Appl. No.: 17/729,090

(22) Filed: Apr. 26, 2022

Related U.S. Application Data
(63) Continuation-in-part of application No. 17/665,145, filed on Feb. 4, 2022.

(51) Int. Cl. G06Q 20/20

(52) U.S. Cl. CPC G06Q 20/208

(57) ABSTRACT

A first Machine-Learning Model (MLM) is processed on multiple images of a scene, each scene comprising a different perspective view of each of a plurality of items. The first MLM produces masks for the items within each image, each mask representing a portion of a given item within a given image. Depth information associated with the images and the masks are processed to isolate each portion of each item within each image. A single scene image is generated from the images by stitching each image’s pixel data from each portion or each image into a composite item image within the single scene image. Each item’s composite item image is passed to a second MLM and the second MLM returns an item code for the corresponding item associated with the corresponding composite item image. The item codes for each item is passed to a transaction manager to process a transaction.

### RELATED APPLICATIONS

The present application is Continuation-In-Part (CIP) of Application No. 17,665,145 entitled “Multi-Item Product Recognition for Checkouts” filed on Feb. 4, 2022, the disclosure of which is incorporated in its entirety herein and below.

### BACKGROUND

Item recognition by itself is a difficult task when the number of images for the item is small and when some of the images occlude the item. Multi-item recognition is even more difficult for many reasons, such as more occlusion of items that is present in the images (the items can be placed in front of one another). In fact, placing many items in one area at once inevitably leads to some items blocking the view of other items. Even if some item is visible in an image, a key identifying feature of that item may still be out of sight or blocked.

Many retailers offer a variety of forms of checkout to their customers. For example, cashier-assisted checkouts allow customers to place items on the conveyor belt and a cashier handles each item to scan or enter its item code and takes payment from the customer for checkout while operating a Point-Of-Sale (POS) terminal. Self-Service Terminals (SSTs) allow customers to scan or enter their own item barcodes and make payment for self-checkouts. Some retailers allow customers to use a mobile application to scan or enter item barcodes as the customers shop and pay either at a SST, POS terminal, of via the mobile application for checkout.

The goal of the industry is to permit frictionless checkouts where cameras and sensors associate the customer with an account within a store, monitor items the customer picks up, recognize the items from images of the camera, and charge a payment for the transaction of the customer when the customer leaves the store.

Frictionless shopping also encounters the occlusion problem because a customer’s hands or other items may occlude an item and the item may be stacked onto other items within a customer’s bag or basket such that a good image of the item may not be capable of being obtained to identify the item.

Convenience stores usually have small baskets and checkouts involve store assistants available to assist shoppers to enter or scan item codes (UPC) at Point-Of-Sale (POS) terminals operated by the store assistants. Unfortunately, convenience stores lack the physical space to install Self-Service Terminals (SSTs), which would allow the shoppers to perform self-checkouts with their items.

Each of the different types of checkouts all have to deal with item recognition to streamline or automated the checkout process. Given that there are often hundreds to thousands of items in a product catalogue, distinguishing between items is challenging. Some products may have similar appearance, and a same product may change its appearance over time based on seasonal promotions, updates to branding, etc.

Many approaches to item recognition involve complex convolutional neural networks (CNN). These models are robust in identifying and classifying objects and perform well with respect to speed. However, the downside to these models is their need for large volumes of training data to reach an acceptable degree of item recognition accuracy. Given the periodic change in appearance of products and the continual addition of new products to a store’s inventory, collecting training data (in the form of images from a variety of camera and camera viewpoints) for each new item can be tedious, labor extensive/expensive, and never ending.

### SUMMARY

In various embodiments, a system and methods for checkout product recognition are presented.

According to an embodiment, a method for checkout product recognition is provided. Masks for items are obtained in images captured of a scene and depth information is obtained for each of the items in each of the images. Pixel data associated with each item in each of the images is stitched into a composite item image using the corresponding mask and the corresponding depth information for the corresponding item obtained from the images. An item code for each composite item image in the scene is provided to a transaction manager for processing a transaction associated with the items.

### BRIEF DESCRIPTION OF THE DRAWINGS

FIG. 1 is a diagram of a system for multi-item checkout product recognition, according to an example embodiment.

FIG. 2 is a diagram of a method for checkout product recognition, according to an example embodiment.

FIG. 3 is a diagram of another method for checkout product recognition, according to an example embodiment.

### DETAILED DESCRIPTION

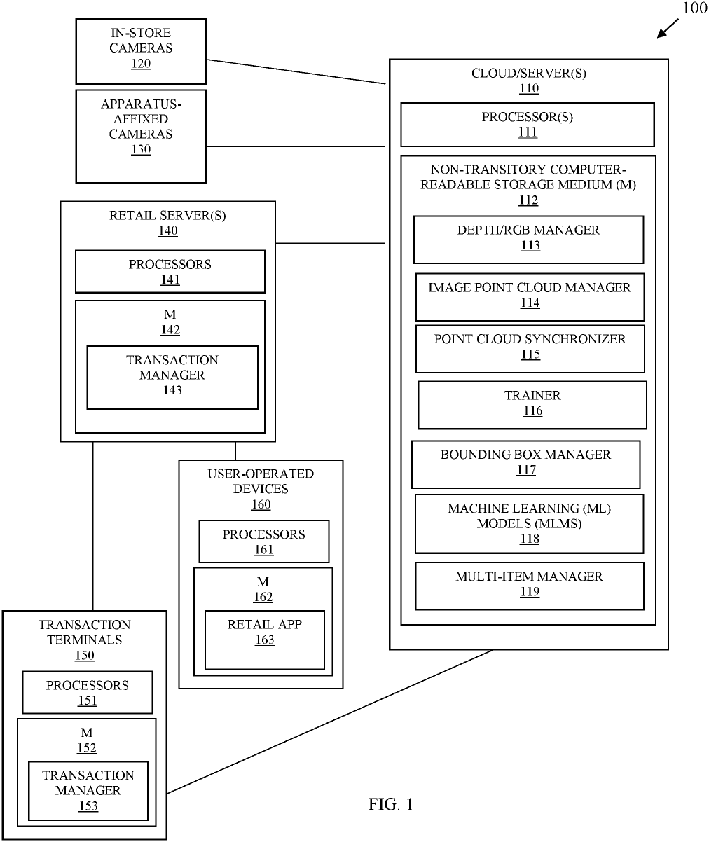

FIG. 1 is a diagram of a system 100 for checkout product recognition, according to an example embodiment. It is to be noted that the components are shown schematically in greatly simplified form, with only those components relevant to understanding of the embodiments being illustrated.

Furthermore, the various components (that are identified in system/platform 100) are illustrated and the arrangement of the components are presented for purposes of illustration only. It is to be noted that other arrangements with more or less components are possible without departing from the teachings of checkout product recognition, presented herein and below.

As used herein a “scene” refers to a defined area where a set or multi-items of a customer are being monitored through multiple images taken at multiple different angles. The multi-items can be stationary or can be moving with the customer in a basket, a cart, in their hands and arms, or in a bag. The area can be any predefined shape, predefined size, and predefined dimensions.

System 100 illustrates a variety of components that permit multiple images of items (products each item having an image from a different angle and perspective than another camera) captured at different angles by multiple different types of cameras 120 or cameras 130 of a same type within a scene. The items may be placed together in a basket, in a cart, held by a customer, and/or placed on a countertop when the images of the scene are captured and provided to cloud/server 110. Depth information returned by the cameras 120 and/or 130 and Red, Green, Blue (RGB) color data returned by the cameras 120 and/or 130 are used to create point clouds representing the scene as captured by each camera 120 or 130. The point cloud representing the 3-dimensional 3D image of a given item in the area/space in which each of the separate images were taken by multiple cameras 130

The point clouds are then aligned and synchronized to create a single point cloud of the scene, since each separate camera 120 or 130 has a field of view that is pre-mapped to the scene and the lens of each camera 120 or 130 is at a preset angle and distance from the scene. This allows the depth information and RGB data for each item in the scene to be associated with a given location (clustered) within the scene and the depth information and RGB data for each item integrated together in a single point cloud.

The depth information and RGB data is clustered together based on nearness (closeness/distance between other depth information and RGB data) within the scene. A total number of items in the scene is then counted based on the number of clusters associated with depth information and RGB data. A three-dimensional (3D) bounding box is placed around each individual item (cluster). Each cluster within each 3D bounding box representing a stitched together 3D image (reassembled single image) of each image in the scene. The pixel data (can be RGB data and/or greyscale depth pixel data in the depth information) associated with each cluster (each unique item within the point cloud) and provided as input to a trained machine-learning model that outputs a confidence level as a percentage that a given item is associated with a specific item code from a product catalogue of a retailer. The location of each of the cluster of points in the point cloud can be obtained and associated with the corresponding 2D RGB image, so that each item can be associated across all the images or camera views. As such, multiple views of a single item are considered when determining the item code for any given cluster within the point cloud.

Essentially, a pipeline of operations are performed on multiple images taken of a scene, the scene comprises multiple items placed within the scene. Accuracy of a total item count for the multiple items and item recognition for each of the multiple items is improved through processing the pipeline of operations.

There are challenges associated with accurately placing a bounding box around each item in a scene because some bounding boxes may include pixels associated with one or more adjacent items and/or may include background pixels associated with a scene in which the images were taken. Another challenge is training Machine-Learning Models (MLMs) to perform various tasks because training can be tedious, ongoing, and labor intensive/expensive. Still another challenge is any MLM designed to classify an item is typically unable to address a new item or an item whose appearance has changed over time.

System 100 provides techniques by which these challenges are overcome.

Various embodiments are now discussed in great detail with reference to FIG. 1.

System 100 comprises a cloud/server 110, in-store cameras 120, apparatus-affixed cameras 130, one or more retail server 140, transaction terminals 150, and user-operated devices 160.

Cloud/Server 110 comprises a processor 111 and a non-transitory computer-readable storage medium 112. Medium 112 comprises executable instructions for a depth/RGB manager 113, an image point cloud manager 114, a point cloud synchronizer 115, a MLM trainer 116, a bounding box manager 117, a plurality of MLMs, 118, and a multi-item management 119. The executable instructions when provided or obtained by the processor 111 from medium 112 cause the processor 111 to perform operations discussed herein with respect to 113-119.

In-store cameras 120 may be stationary cameras placed throughout a store, such as overhead cameras situated overhead of transaction areas of terminals 150 and/or situated along side countertops associated with terminals 150.

Apparatus-affixed cameras 130 may be affixed to the sides of baskets and carts. One camera 130 for a cart or a basket may be placed along a top edge of the cart or basket and pointed down into the basket or cart. Other cameras 130 for the cart or basket may be affixed to 2 or more sides of the cart or basket focused into the cart or basket.

In an embodiment, only apparatus-affixed cameras 130 are used for the embodiments discussed below.

In an embodiment, only in-store cameras 120 are used for the embodiments discussed below.

In an embodiment, a combination of in-store cameras and apparatus-affixed cameras 130 are used for the embodiments discussed below.

In an embodiment, 3 cameras 120 and/or 130 are used for the embodiments discussed below.

In an embodiment, 4 cameras 120 and/or 130 are used for the embodiments discussed below.

In an embodiment, 5 or more cameras 120 and/or 130 are used for the embodiments discussed below.

In an embodiment, one or all of the cameras 120 and/or 130 are depth cameras.

Each retail server 140 comprises at least one processor 141 and a non-transitory computer-readable storage medium 142. Medium 142 comprises executable instructions for a transaction manager 143. The executable instructions when provided or obtained by the processor 141 from medium 142 cause the processor 141 to perform operations discussed herein with respect to 143.

Each transaction terminal 150 comprises at least one processor 151 and a non-transitory computer-readable storage medium 152. Medium 152 comprises executable instructions for a transaction manager 153. The executable instructions when provided or obtained by the processor 151 from medium 152 cause the processor 151 to perform operations discussed herein with respect to 153.

Each user-operated device 160 comprises at least one processor 161 and a non-transitory computer-readable medium 162. Medium 162 comprises executable instructions for a retail application (app) 163. The executable instructions when provided or obtained by the processor 161 from medium 162 cause the processor 161 to perform operations discussed herein with respect to 163.

Initially, a first MLM 118 is trained as an item/product segmentation model by trainer 116. A first set of items is obtained for training and placed on a terminal countertop, a basket, and/or a cart. Cameras 120 and/or 130 capture multiple images of a given item in the set from multiple angles and positions on the countertop and/or within the basket and/or cart. A Graphical User Interface (GUI) tool is used to draw and control outline around the item. This outline corresponds to specific pixels within each image that identifies the boundary of the item within each image (item segmentation). The modified images for a single item is then past to a first MLM 118 by trainer with the outline from each image expected to be returned as output by the first MLM 118 as segmentation or an outline for each image for that item associated with the multiple images.

After an initial training of the first MLM 118 on multiple images for each of a first set of item images, a second set of items most frequently and likely to be encountered by a given store is selected and similarly these items are placed on the countertop of the terminal 150 and/or placed within a basket and/or cart and a set of images for each item is produced. Trainer 116 passes each set to the initially trained first MLM 118 and the output consists of segmentations or outlines predicted by the first MLM 188 for each item in each image for the set of images associated with the corresponding item. From the resulting output images produced by the trained first MLM 118, the most accurate in providing the segmentation outline for each item is set aside for a second training session with the first MLM 118. Trainer 116 uses the set aside images and performs a second training session on first MLM 118. The images with poor or unacceptable item segmentation produced by the MLM 118 are set aside and processed back through the twice trained first MLM 118 and the processes is repeated with each new training session on the first MLM 118 using item images set aside that had the most accurate segmentation produced as output by the first MLM 118, the inaccurate segmentation items are ran back through a last training of the first MLM 118, etc., until the first MLM 118 produces acceptable and accurate segmentation on any item from any given image.

This allows for first MLM 118 to use transfer learning and only requires the manual segmentation drawing via a GUI on just a first set of items not all the items. This allows trainer 116 to iteratively train the first MLM 118 in a snowball manner after the first training session and substantially reduces training time and manual intervention time while at the same time improves the accuracy of the segmentation output by the first MLM 118.

Multi-item manager 119 uses a set of images for a set of item received by cameras 120 and/or 130 for a given transaction and passes the images to the fully trained first MLM 118. This generates masks for each unique item in the scene associated with the images, each mask corresponding to a unique item. The mask image is then modified such that any pixel associated with an item (inside the segmentation boundary generated by the first MLM 118) is set to a pixel value of 1 and any pixel outside the segmentation boundary is set to 0. Two or more items that may have partially occluded the other within the set of images taken of the scene and background objects/details associated with the scene are now completely segmented, such that the background pixels are identified as having a pixel value of 0.

However, because the masks may not be completely accurate or a 100% accurate within a multi-view of each item within the scene and because there are multiple images having the masks. Multi-view association is performed to identify and associate each mask from the each image of the set of images with a particular unique item present in the scene. The goal is to uniquely identify a single item in a plurality of different items from multiple images taken of the scene where the items are located within the scene. Masking allows removal of background pixels associated with the scene, such that only pixels of the items remain, but there are still multiple images of each single item.

Multi-item manager 119 obtains depth information and Red Green Blue (RGB) information from depth/RGB manager 113 for each image in the set of images for the scene from the corresponding cameras 120 and/or 130. Image point cloud manager 114 creates a plurality of 3D point clouds for each image, each camera 120 and/or 130 is associated with a region and a view within the scene, such that point cloud synchronizer 115 clusters each of the point clouds into a single point cloud. At this point, bounding box manager 117 places a bounding box around each clustered set of images, each set of images from the single point identifying a single item that was present in the view.

Alternatively, the multi-item manager uses the segmentation masks from the images and the known regions and views of the cameras 120 and/or 130 along with the 3D point clouds to cluster the item images for a single item together without any bounding boxes. The segmentation mask approach allows background pixels for the scene to be automatically removed such that it can be more accurate than the bounding box approach discussed above.

The multi-item manager 119 then uses the masks, the clusters of masks of the bounding boxes, the single 3D point cloud, and obtains the RGB data from the original sets of images for the scene to stitch together RGB data for each unique item present in the scene. That is, each item and its unique RGB pixels are assembled into a single image and in a set of images, each image in the set only containing the corresponding item’s RGB pixel data.

Once this is done and we have the unique RGB data from a scene for each unique item in the scene, multi-item manager 119 can perform a variety of techniques using one or more second MLMs 118 for purposes of obtaining each item’s item code (classification).

Trainer 116 employs a different training technique or a similar training technique when training the one or more second MLMs 118. Classification differs from segmentation; the first MLM 118 (segmentation model 118) has a task of identifying any item in an input image and outputting the boundary around that item. Once sufficiently trained segmentation model 118 works well on unseen data (new items encountered), producing accurate segmentation boundaries for items never seen before. A classifier MLM 118 on the other hand must be able to predict an exact identity (item code) of any given item by choosing its identify over all other item codes it has been trained on.

If a new item is added to a store’s inventory, a classification model needs to be retrained to include a new class for the item so that it is able to predict the item during subsequent sessions. Similarly, if an appearance of an item changes due to, for example, a seasonal promotion or a branding change, the model will need to be retrained with images of this new appearance, so the model knows to associate the new appearance with the item code (item identity).

Because CNN models require a large volume of images for each item class to train on, the process of collecting data for each new or updated item may be quite tedious.

System 100 addresses this issue using a Metric Learning approach, where a representative feature of each image is designated during training by trainer 116. The representative features can range from the image itself, to descriptive statistics on the training image, to output of a third MLM 118 tasked to learn embeddings, the third MLM 118 may be referred to as an Encoder.

Trainer 116 takes a new training image based to it and features are generated for the image and compared with all of the features the second Metric Learning MLM 118 has already been trained on. A distance function, such as Mahalabobis distance or Cosine distance, is processed by trainer 116 to identify features in the training image most similar to the inference features and provided by the trainer during training as input to the Metric Learning MLM 118 during a training session. This is similar to a k-Nearest Neighbor (KNN) MLM.

The second Metric Learning MLM 118 can learn information about new or updated models by generating features for just one or a handful of images. But this approach may not scale well enough based on the sheer number of items available in a store’s item catalogue. Thus, multiple different second MLMs 118 are trained by trainer 116 to reduce the search space needed of the second Metric Learning MLM 118.

Multi-item manager 119 bins/routes the images received into a specific one of the second MLMs 118. For example, different items/products tend to have different shapes. Bottles have different shapes than cans, bags of chips, candy bars, etc. Each of the second MLMs 118 are trained on a specific shape. So, multi-item manager 119 receives an image of an item, runs a shape detection algorithm and selects a particular second MLM 118 based on the shape. This could also be done based on image statistic attributes or other attributes gleaned from the point cloud and/or the RGB data of the image.

In an embodiment, multi-item manager 119 uses a second Metric Learning MLM 118 first and bins or routes the image to a different second MLM 118 based on the initial classification output by the second Metric Learning MLM 118 using any of the above techniques to determine the appropriate different second MLM 118. Here, second MLMs 118 form a pipeline processed to resolve each item’s identity (item code).

In an embodiment, system 100 improves on the item classification response time by taking multiple images of a single item taken in a scene by multiple cameras 120 and/or 130 (the scene consisting of multiple items) and stitching the multiple images of the single item into one image. This reduces the number of images per item passed to the classification MLMs 118. In such cases, the classification MLMs 118 may be trained by trainer 116 on stitched images of items to improve the accuracy of the classification MLMs 118.

In an embodiment, system 100 improves on item classification response time by reducing the dimensionality of the images and using trainer 116 to train the classification MLMs 118 on non-stitched images or stitched images.

Once the classification MLMs 118 produce a classification prediction as to an item identity (item code), multi-item manager 119 can select an optimal item code prediction in a variety of manners. Once the item code prediction is accepted for a given item of the scene, the item code for that item is passed to transaction manager 143 and/or 153 to complete a transaction being processed. It is noted that a variety of different pipelines of second MLMs 118 or a single second MLM 118 can be used processed utilizing one or different types of M (CNN, Metric Learning, shape specific, statistic specific, etc.).

The original sets of images for the scenes as modified by the techniques discussed above to mask or bound (via bounding box) each unique item image in each image of the scene and include just the pixel RGB data for each corresponding item within the mask or bounding box, is passed as input by manager 119 to one or more second MLMs 118 for classification of the items in the scene.

In an embodiment, a single modified stitched point cloud image is sent to one or more second MLMs 118 for classification of the items in the scene.

In an embodiment, multi-item manager 119 passes each of the modified scene images to a CNN (second) MLM 118. For example, if there were 5 images for the scene, each item is associated with 5 images and each of those 5 images comprise just the RGB data known to be associated with each item in a separate cluster or a separate mask. In this scenario, assuming there are 5 items in each scene associated with 5 separate scene images, the 5 scene images are passed as input to the CNN (second) MLM 118. When the CNN (second) MLM 118 is provided a given item set of 5 images for the scene, five outputs are returned with a particular mask/cluster/bounding box for item B identified as item code X in 3 of the 5 outputs and item code Y in two of the outputs. Multi-item manager 119 selects item code X as the item code for item B and passes this to transaction manager 143 and/or 153 for a given transaction.

In an embodiment, a multi-item manager 119 passes a single stitched image (as discussed above) per item to a CNN second MLM 118 and when the confidence value returned (X %) is above a threshold percentage, manager 119 selects the item code associated with the confidence value.

In an embodiment, multi-item manager 119 passes a single stitched image per item to a Metric Learning second MLM 118, rather than returning a confidence value (%), the Metric Learning MLM 118 returns a distance value, such that a large distance is not a good match, a short distance is a good match, so if an image for item B causes Metric Learning MLM 118 to return a small distance value (based on a threshold distance comparison), such as 0.1, manager 119 selected item code N for the item code B and passes this to the transaction manager 143 and/or 153.

In an embodiment, manager 119 passes a single stitched image per item simultaneously to a CNN second MLM 118 and a Metric Learning second MLM 118. This causes the CNN MLM 118 to output an ordered list of item codes by confidence percentage (highest to lowest) and causes Metric Learning MLM 118 to output an ordered list of item codes by distance (lowest to highest). Manager 119 then selects the item code having a highest percentage and lowest distance or ignores the highest percentage when it is also associated with the highest distance (based on a threshold distance).

In an embodiment, confidence or distance values are averaged by manager 119 and selected when the average for a given item code is above a threshold value (for a CNN MLM 118) or below a threshold for a Metric Leaning MLM 118).

In an embodiment, manager 119 preprocesses the images as discussed above before passing the images to the Metric Learning MLM 118 for classification.

In an embodiment, manager 119 selects a type of second MLM 118 to process based on preprocessing information (as discussed above) and passes the images to the selected second MLM 118 for classification.

Once the first segmentation MLM 118 is trained by trainer 116, the second MLMs 118 are trained by trainer, and a workflow is defined for manager 119 (preprocessing images for a Metric MLM 118, preprocessing images for selecting a specific second MLM 118 from a plurality of second MLMs, defined to uses the images directly with one or more second MLMs 118, and configured for selecting the optimal item codes from the output of the second MLM(s) 118), operation of system 100 proceeds as follows.

Multiple items or products are placed in a designated area that cameras 120 and 130 are focused on for capturing a scene of the items from the designated area. The designated area can be stationary (such as a countertop of a transaction area associated with terminals 150 or the designated area can be moving with a customer that has the items placed in a cart (one type of apparatus) or a basket (another type of apparatus) equipped with apparatus-affixed cameras 130.

The images are streamed directly to multi-item manager 119 from the cameras 120 and/or 130 are streamed directly by cameras 120 and/130 into storage of a network-accessible file location that multi-item manager 119 monitors. The images of the scene are provided by multi-item manager 119 to run through the first MLM 118 for masking segmentation, manager 119 also provides the images to depth/RGB manager 113 which extracts the depth information for each of the items and RGB data for each of the items. The depth information for the scene of items and the RGB data for the scene of items is piped directly into image point cloud manager 114.

Image point cloud manager 114 creates point clouds for each image taken by each camera 120 and/or 130 that comprise each image’s extracted depth information and RGB data. The point clouds for the single scene of items is then piped directly into point cloud synchronizer 115.

Point cloud synchronizer 115 uses known information associated with each camera 120 and/or 130 (such as camera angle, camera distance to surfaces of the designated area for the scene, camera quality (density of pixels per inch), etc.) to create a synchronized or mapped single point cloud for the scene that comprises the individual depth information and RGB data for each image patched (stitched) and assembled into the single point cloud. Synchronizer 115 integrates all depth information and RGB data from the point clouds of all the cameras 120 and 130 into a single patched point cloud. Note that the mashing and segmentation first MLM 118 removed background pixel data from the images of the scene. Bounding box manager 117 or the masks can be used to uniquely identify each unique item in each image of the scene.

In an embodiment, to link the images of all the cameras 120 and/130 into a single patched point cloud, point cloud synchronizer 115 utilizes a transformational matrix which aligns a given camera’s coordinates to real-world coordinates associated with the designated area of the scene.

Bounding box manager 117 performs a clustering algorithm on the remaining depth information and RGB data for the scene in the single point cloud or utilizes the masks generated by the first MLM 118. This associates the component point cloud points that each individual camera 120 and/or 130 was contributing. The bounding box manager 117 creates a bounding box (using the mask in some cases) around each cluster, resulting in a single bounding box per item in the scene of the designated area. Each item’s 3D bounding box can be used to create 2D bounding boxes in each 2D RGB image where the item is visible.

Multi-item manager 119 counts the number of bounding boxes in the single point cloud. The count is equal to the number of items present in the scene and the RGB data within the corresponding bounding box are fed individually to one or more second MLMs 118 (as discussed above) for item recognition of each item present within the scene.

In an embodiment instead of the RGB data being fed from the single point cloud by manager 119 to one or more second MLMs 118, the single point cloud is processed to identify where in the original 2D RGB images each item is located. A 2D bounding boxes or masks for each of the original images is created and each of the images are fed to the one or more second MLMs 118 by manager 119. Each image patch (identified by the 2D bounding box or mask in the original image) receives its own item code assignment and confidence value back from the one or more second MLMs 118. The outputs for each patch (potential item code) in each item is considered a “vote”. If a given item path in a given one of the images receives a different item code or an overall average confidence is below a threshold value, the corresponding patches associated with that 2D bounding box in the original RGB images is considered inconclusive. When the averaged confidence value from the votes exceed a threshold value, the corresponding item code is assigned for those patches presenting in the original RGB images.

Each of the one or more second MLMs 118 return a confidence factor or distance association for each bounding box that identifies how confident the MLM 118 is in its item prediction. An item prediction is an item code associated with a given item in a catalogue of a retailer associated with server 140. When the confidence factor exceeds a predefined percentage or distance, multi-item manager 119 assigns the corresponding item code to the corresponding bounding box in the single point cloud for the scene.

In an embodiment, a type of second MLM 118 and a pipeline of more than one second MLM 118 is determined by manager 119. Manager 119 also utilizes customized rules (discussed above as options) to determine what item code to select for any given item presenting in the images of the scene.

Multi-item manager 119 uses an Application Programming Interface (API) to provide each item code for each item in the scene to transaction manager 143 and/or transaction manager 153. Transaction managers 143 and/or 153 may use the item codes for a variety of purposes during checkout of a customer, such as to identify the transaction details and request payment from the customer and/or for security to verify item codes entered or scanned match what was provided by multi-item manager 119 for purposes of raise security alerts or audits of the customer transaction.

In cases where the customer is using retail app 163 to self-shop and checkout of a store, retail app interacts with transaction manager 143 and transaction manager 143 records the item codes provided by manager 119, obtains the item pricing and item descriptions, and maintains an option within app 163 that the customer can select to see what is currently in the customer’s cart or basket along with an option for the customer to checkout at any time.

In an embodiment, system 100 permits the elimination of item bar code scanning during checkouts at terminals 150 that are POS terminals operated by cashiers, permits elimination of item bar code scanning during self-checkouts at terminals 150 that are SSTs operated by the customers. Additionally, system 100 permits elimination of self-scanning by customers of the item bar codes when customers are using retail app 163; rather the customer simply places desired items for their transaction into their cart or basket and the item codes are automatically resolved by system 100 in the manners discussed above.

In an embodiment, any given second MLM 118 is also trained on depth information for each bounded/masked item along with the RGB data. In this way, the given second MLM 118 can identify items of the same type but of a different size, such as distinguishing between an 8-ounce bottle of Coke® from a 12 or 16-ounce Coke®.

In an embodiment when a given item confidence value returned by the one or more second MLMs 118 for a given item in the scene falls below a predefined threshold, multi-item manager 119 sends a message to transaction manager 143 or transaction manager 153 indicating that one item is unaccounted for and cannot be identified. The item code associated with the lower confidence value may also be supplied in the message as a suggestion to provided to a cashier or the customer on what item was not identified. Transaction manager 143 or 153 may use an alert to have the transaction audited by an attendant, such that the item can be identified and properly recorded. The original images associated with the item as determined by the bounding boxes may also be supplied in the message with a request that the customer identify the item or rearrange the items on the designated area of the scene for system 100 to retry and identify the item in question.

In an embodiment, the designated area of the scene is 12 inches by 16 inches or roughly corresponds to the size of a cart, a food tray, a basket or a countertop at a convenience store.

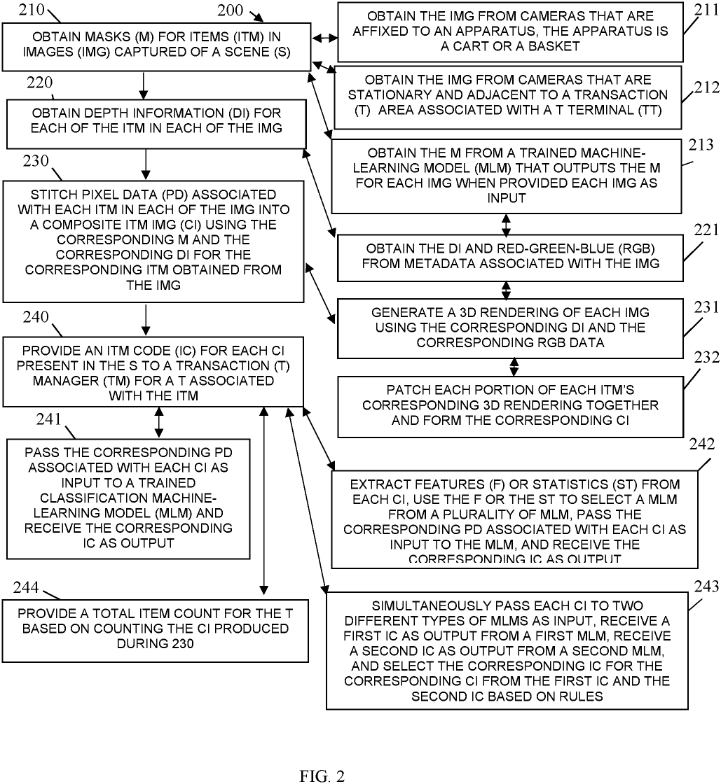

These embodiments and other embodiments are now discussed with reference to the FIGS. 2—3.

FIG. 2 is a diagram of a method 200 for checkout product recognition, according to an example embodiment. The software module(s) that implements the method 200 is referred to as a “scene item identifier.” The scene item identifier is implemented as executable instructions programmed and residing within memory and/or a non-transitory computer-readable (processor-readable) storage medium and executed by one or more processors of a device. The processor(s) of the device that executes the scene item identifier are specifically configured and programmed to process the scene item identifier. The scene item identifier has access to one or more network connections during its processing. The network connections can be wired, wireless, or a combination of wired and wireless.

In an embodiment, the scene item identifier executes on cloud 110. In an embodiment, the scene item identifier executes on server 110.

In an embodiment, the scene item identifier is all or some combination of 113, 114, 115, 116, 117, 118, and 119.

At 210, the scene item identifier obtains masks for items in images captured of a scene.

In an embodiment, at 211, the scene item identifier obtains the images from cameras 130 that are affixed to an apparatus and the apparatus is a card or a basket.

In an embodiment, at 211, the scene item identifier obtains the images from cameras 120 that are stationary and adjacent to a transaction area associated with a transaction terminal.

In an embodiment, at 213, the scene item identifier obtains the masks from a trained MLM 118 that outputs the masks for each image when provided each image of the scene as input.

At 220, the scene item identifier obtains depth information for each of the items in each of the images for the scene.

In an embodiment of 213 and 220, at 221, the scene item identifier obtains the depth information and Red-Green-Blue (RGB) data from metadata associated with the images of the scene.

At 230, the scene item identifier stitches or patches pixel data associated with each item in each of the images into a single composite item image using the corresponding mask and the corresponding depth information for the corresponding item obtained from the images of the scene.

In an embodiment of 221 and 230, at 231, the scene item identifier generates a 3D rendering of each image using the corresponding depth information and the corresponding RGB data.

In an embodiment of 231 and at 232, the scene item identifier patches each portion of each item’s corresponding 3D rendering together and forms the corresponding composite item image.

At 240, the scene item identifier provides an item code for each composite item image to a transaction manager 153 for a transaction associated with the items.

In an embodiment, at 241, the scene item identifier passes the corresponding pixel data associated with each composite item image as input to a trained MLM 118 and receives the corresponding item code as output.

In an embodiment, at 242, the scene item identifier extracts features of statistics from each composite item image, uses the features or the statistics to select a MLM 118 from a plurality of MLMs 118, passes the corresponding pixel data associated with each composite item image as input to the MLM 118, and receives the corresponding item code as output.

In an embodiment, at 243, the scene item identifier simultaneously passes each composite item image to two different types of MLMs 118 as input, receives a first item code as output from a first MLM 118, receives a second item code as output from a second MLM 118, and selects the corresponding item code for the corresponding composite item image from the first item code and the second item code based on rules processed by the scene item identifier.

In an embodiment, at 244, the scene item identifier provides a total item count for the transaction to the transaction manager 153 based on counting the composite item images produced during 230.

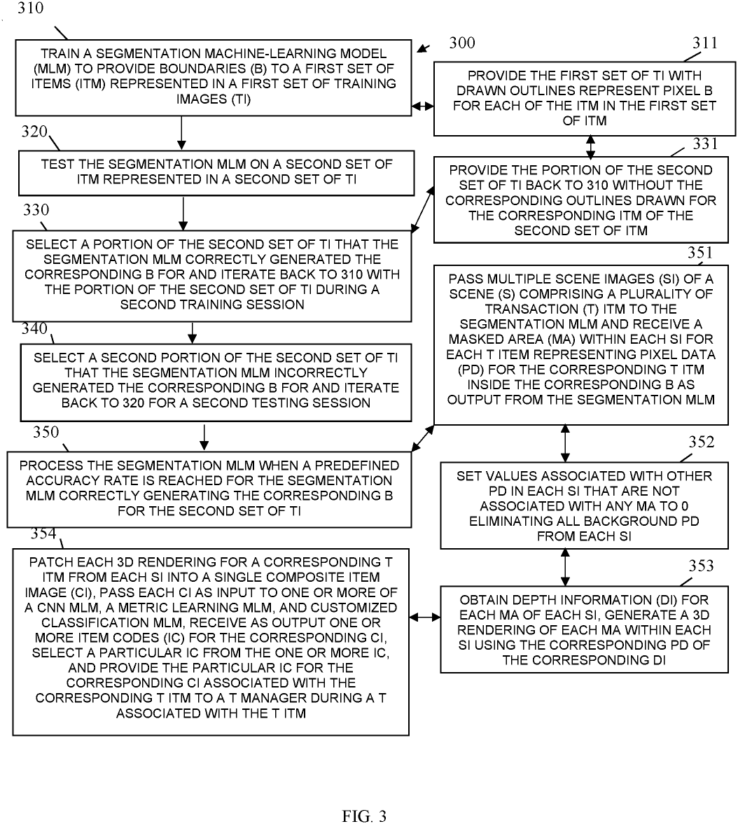

FIG. 3 is a diagram of another method 300 for checkout product recognition during a checkout, according to an example embodiment. The software module(s) that implements the method 200 is referred to as a “segmentation mask model trainer.” The segmentation mask model trainer is implemented as executable instructions programmed and residing within memory and/or a non-transitory computer-readable (processor-readable) storage medium and executed by one or more processors of a device. The processor(s) of the device that executes the segmentation mask model trainer are specifically configured and programmed to process the segmentation mask model trainer. The segmentation mask model trainer has access to one or more network connections during its processing. The network connections can be wired, wireless, or a combination of wired and wireless.

In an embodiment, the device that executes the segmentation mask model trainer is cloud 110. In an embodiment, the device that executes the segmentation mask model trainer is server 110.

In an embodiment, the segmentation mask model trainer is all or some combination of 113, 114, 115, 116, 117, 118, 119, and/or method 200.

At 310, the segmentation mask model trainer trains a segmentation MLM 118 to provide boundaries to a first set of items represented in a first set of training images.

In an embodiment, at 311, the segmentation mask model trainer provides the first set of training images with drawn outlines representing pixel boundaries for each of the items in the first set of items.

At 320, the segmentation mask model trainer tests the segmentation MLM 118 on a second set of items represented in a second set of training images.

At 330, the segmentation mask model trainer selects a portion of the second set of training images that the segmentation MLM 118 correctly generated the corresponding boundaries for, and the segmentation mask model trainer iterates back to 310 (training) with the portion of the second set of training images during a second training session with the segmentation MLM 118.

In an embodiment of 311 and 330, at 331, the segmentation mask model trainer provides the portion of the second set of training images back to 310 without the corresponding outlines drawn for the corresponding items of the second set of items.

At 340, the segmentation mask model trainer selects a second portion of the second set of training images that the segmentation MLM 118 incorrectly generated the corresponding boundaries for, and the segmentation mask model trainer iterates back to 320 (testing) for a second testing session on the second portion of the second set of training images.

At 350, the segmentation mask model trainer processes the segmentation MLM 118 when a predefined accuracy rate is reached for the segmentation MLM 118 correctly generating the corresponding boundaries for the second set of training images.

In an embodiment at 351, the segmentation mask model trainer passes multiple scene images for a scene comprising a plurality of transaction items to the segmentation MLM 118 as input. The segmentation mask model trainer receives as output from the segmentation MLM 118 a masked area within each scene image for each transaction item representing pixel data for the corresponding transaction item inside the corresponding boundaries.

In an embodiment of 351 and at 352, the segmentation mask model trainer sets values associated with other pixel data in each scene image that are not associated within any masked area to 0; thereby, excluding all background pixel data from each of the scene images that are not associated within any transaction item.

In an embodiment of 352 and at 353, the segmentation mask model trainer obtains depth information for each masked area of each scene image and generates a 3D rendering of each masked area within each scene image using the corresponding pixel data and the corresponding depth information.

In an embodiment of 353 and at 354, the segmentation mask model trainer patches each #d rendering for a corresponding transaction item from each scene image into a single composite item image. The segmentation mask model trainer passes each single composite item image as input to one or more of: a CNN MLM 118, a Metric Learning MLM 118, and a customized classification MLM 118. The segmentation mask model trainer receives as output one or more item codes for the corresponding composite item image. The segmentation mask model trainer selects a particular item code from the one or more item codes and provides the particular item code for the corresponding composite item image associated with the corresponding transaction item to a transaction manager 153 during a transaction associated with the transaction items.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
obtaining masks for items in images captured of a scene;
obtaining depth information for each of the items in each of the images;
stitching pixel data associated with each item in each of the images into a composite item image using the corresponding mask and the corresponding depth information for the corresponding item obtained from the images; and
providing an item code for each composite item image present in the scene to a transaction manager for processing a transaction associated with the items.

2. The method of claim 1, wherein obtaining the masks further includes obtaining the images from cameras that are affixed to an apparatus, wherein the apparatus is a cart or a basket.

3. The method of claim 1, wherein obtaining the masks further includes obtaining the images from cameras that are stationary and adjacent to a transaction area associated with a transaction terminal.

4. The method of claim 1, wherein obtaining the masks further includes obtaining the masks from a trained Machine-Learning Model (MLM) that outputs the masks for each image when provided each image as input.

5. The method of claim 4, wherein obtaining the depth information further includes obtaining the depth information and the RGB data from metadata associated with the images.

6. The method of claim 5, wherein stitching further includes generating a three-dimensional 3D rendering of each image using the corresponding depth information and the corresponding RGB data.

7. The method of claim 6, wherein generating further includes patching each portion of each item’s corresponding 3D rendering together forming the corresponding composite item image.

8. The method of claim 1, wherein providing further includes passing the corresponding pixel data associated with each composite item image as input to a trained classification Machine-Learning Model (MLM) and receiving the corresponding item code as output.

9. The method of claim 1, wherein providing further includes extracting features or statistics from each composite item image, using the features or statistics to select a Machine-Learning Model (MLM) from a plurality of MLMs, passing the corresponding pixel data associated with each composite item image as input to the MLM, and receiving the corresponding item code as output.

10. The method of claim 1, wherein providing further includes simultaneously passing each composite item image to two different types of Machine-Learning Models as input, receiving a first item code as output from a first MLM, receiving a second item code as output from a second MLM, and selecting the corresponding item code for the corresponding composite item image from the first item code and the second item code based on rules.

11. The method of claim 10, wherein providing further includes providing a total item count for the transaction to the transaction manager based on counting the composite item images produced during the stitching.

12. A method, comprising:
training a segmentation Machine-Learning Model (MLM) to provide boundaries to a first set of items represented in a first set of training images;
testing the segmentation MLM on a second set of items represented in a second set of training images;
selecting a portion of the second set of training images that the segmentation MLM correctly generated the corresponding boundaries for and iterating back to the training with the portion of the second set of training images during a second training session;
selecting a second portion of the second set of training images that the segmentation MLM incorrectly generated the corresponding boundaries for and iterating back to the testing during a second testing session; and
processing the segmentation MLM when a predefined accuracy rate is reached for the segmentation MLM correctly generating the corresponding boundaries for the second set of training images.

13. The method of claim 12, wherein training further includes providing the first set of training images with drawn outlines representing the pixel boundaries for each of the items in the first set of items.

14. The method of claim 13, wherein selecting further includes providing the portion of the second set of training images back to the training without the corresponding outlines drawn for the corresponding items of the second set of items.

15. The method of claim 12, wherein processing further includes passing multiple scene images of a scene comprising a plurality of transaction items to the segmentation MLM as input and receiving a masked area within each scene image for each transaction item representing pixel data for the corresponding transaction item inside the corresponding boundary as output from the segmentation MLM.

16. The method of claim 15, wherein passing further includes setting values associated with other pixel data in each of the scene images that are not associated with any masked area to 0 eliminating all background pixel data from each of the scene images.

17. The method of claim 16, wherein setting further includes obtaining depth information for each masked area of each scene image, generating a three-dimensional rendering of each masked area within each scene image using the corresponding pixel data and the corresponding depth information.

18. The method of claim 17, wherein obtaining the depth information further includes patching each three-dimensional rendering for a corresponding transaction item from each scene image into a single composite item image, passing each composite item image as input to one or more of a Convolution Neural Network MLM, a Metric Learning MLM, and a customized classification MLM, receiving as output one or more item codes for the corresponding composite item image, selecting a particular item code from the one or more item codes, and providing the particular item code for the corresponding composite item image associated with the corresponding transaction item to a transaction manager during a transaction associated with the transaction items.

19. A system, comprising:
a plurality of depth cameras;
a server comprising at least one processor and a non-transitory computer-readable storage medium;
the non-transitory computer-readable storage medium comprises executable instructions; and
the executable instructions when executed by the at least one processor from the non-transitory computer-readable storage medium cause the at least one processor to perform operations comprising:
obtaining images from the depth cameras associated with a transaction for transaction items, each image representing a scene that comprises the transaction items;
providing the images of the scene to a segmentation Machine-Learning Model (MLM) that returns each image with masked areas, each masked area representing pixel data within the corresponding image for a given one of the transaction items;
obtaining depth information from the images;
generating a three-dimensional (3D) rendering of a portion of each transaction item within each image using the corresponding masked area and the corresponding depth information;
stitching each 3D rendering corresponding to each transaction item from the images into a single composite item image for the corresponding transaction item;
providing the pixel data corresponding to each composite item image to a classification MLM that returns potential item codes for the corresponding composite item image;
selecting a particular potential item code from the potential item code for each composite item image; and
providing each particular potential item code for each transaction item to a transaction manager for processing with the transaction.

20. The system of claim 19, wherein the depth cameras are affixed to a basket, or a cart carried by the customer or wherein the depth cameras are affixed to or surround a transaction area associated with a transaction terminal where the customer is performing the transaction.
